(19) United States
(12) Patent Application Publication
(10) Pub. No.: US 2006/0064650 A1
(43) Pub. Date: Mar. 23, 2006

(54) Method, system, and computer program product for type-based table navigation

(75) Inventor: Jason A. Sholl, Cary, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/945,328

(22) Filed: Sep. 20, 2004

(51) Int. Cl. G06F 17/00

(52) U.S. Cl. 715/827; 715/854

(57) ABSTRACT

The present invention provides a method, system, and computer program product for type-based table navigation. The method comprises: selecting a data type; activating a type-based navigation mode; and navigating exclusively between data of the selected data type in an arrangement of data, wherein data not of the selected data type in the arrangement of data is skipped. When the type-based navigation mode is subsequently deactivated, a user can navigate through any of the data in the arrangement of data regardless of data type.

### BACKGROUND OF THE INVENTION

1. Field of the Invention

The present invention generally relates to tables of data. More particularly, the present invention provides a method, system, and computer program product for type-based table navigation.

2. Related Art

An illustrative table 10 comprising a plurality of rows 12 and a plurality of columns 14 is depicted in FIG. 1. In this example, each cell 16 in table 10 contains a data type comprising text (e.g., “Text”), a Uniform Resource Locator (e.g., “URL”), or a number (e.g., “1234”). A user can navigate through the cells 16 of table 10 using the “tab” key and/or “arrow” keys (e.g., →, ←, ↑, ↓) found on a conventional keyboard. For example, to navigate using the tab key through table 10 from the first cell 16 in table 10 (i.e., row 1, column 1) to each of the cells 16 in table 10 containing an URL data type, a user must press the tab key twenty-seven times. To this extent, each time the tab key is pressed, the cell 16 immediately to the right of a currently selected cell 16 is selected or, if the tab key is pressed after the last cell 16 in a row 12 has been selected, the first cell 16 in the next row 12 is selected. The resultant navigation path 18 through table 10 from the first cell 16 in table 10 (i.e., row 1, column 1) to the last cell 16 in table 10 containing an URL data type (i.e., row 5, column 4) is shown in FIG. 2, wherein each tab is represented by a dashed arrow 20.

As can be seen in FIG. 2, a large number of cells along the navigation path through the table 10 contain an irrelevant data type (e.g., a data type other than an URL) that may not be of interest to the user. As such, much time and numerous keystrokes are wasted when navigating through the table 10 in this manner. This problem is greatly amplified when using larger tables of data containing, for example, hundreds or even thousands of cells. Accordingly, there exists a need for a method, system, and computer program product for reducing the number of keystrokes required to navigate to and between cells of a particular data type in an arrangement of data such as a table.

### SUMMARY OF THE INVENTION

In general, the present invention provides a method, system, and computer program product for type-based table navigation. In particular, the present invention allows a user to quickly navigate to and between cells of a table based on the data type contained within the cells. This reduces the number of cells a user is required to navigate because only the cells containing data of a desired data type are navigable and all other cells are skipped.

A first aspect of the present invention is directed to a method for type-based navigation of data, comprising: selecting a data type; activating a type-based navigation mode; and navigating exclusively between data of the selected data type in an arrangement of data, wherein data not of the selected data type in the arrangement of data is skipped.

A second aspect of the present invention is directed to a system for type-based navigation of data, comprising: a system for selecting a data type; a system for activating a type-based navigation mode; and a system for navigating exclusively between data of the selected data type in an arrangement of data, wherein data not of the selected data type in the arrangement of data is skipped.

A third aspect of the present invention is directed to a program product stored on a recordable medium for type-based navigation of data, which when executed comprises: program code for selecting a data type; program code for activating a type-based navigation mode; and program code for navigating exclusively between data of the selected data type in an arrangement of data, wherein data not of the selected data type in the arrangement of data is skipped.

A fourth aspect of the present invention is directed to a method for deploying an application for type-based navigation of data, comprising: providing a computer infrastructure being operable to: select a data type; activate a type-based navigation mode; and navigate exclusively between data of the selected data type in an arrangement of data, wherein data not of the selected data type in the arrangement of data is skipped.

A fifth aspect of the present invention is directed to computer software embodied in a propagated signal for type-based navigation of data, the computer software comprising instructions to cause a computer system to perform the following functions: select a data type; activate a type-based navigation mode; and navigate exclusively between data of the selected data type in an arrangement of data, wherein data not of the selected data type in the arrangement of data is skipped.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a table comprising cells of a plurality of different data types.

FIG. 2 depicts a navigation path through the table of FIG. 1 in accordance with a method of the prior art.

FIG. 3 depicts a navigation path through the table of FIG. 1 in accordance with an embodiment of the present invention.

FIG. 4 depicts additional navigation paths through the table of FIG. 1 in accordance with an embodiment of the present invention.

FIG. 5 depicts a flow diagram of a method in accordance with an embodiment of the present invention.

FIG. 6 illustrates another embodiment of the present invention.

FIG. 7 depicts a computer system for implementing the present invention.

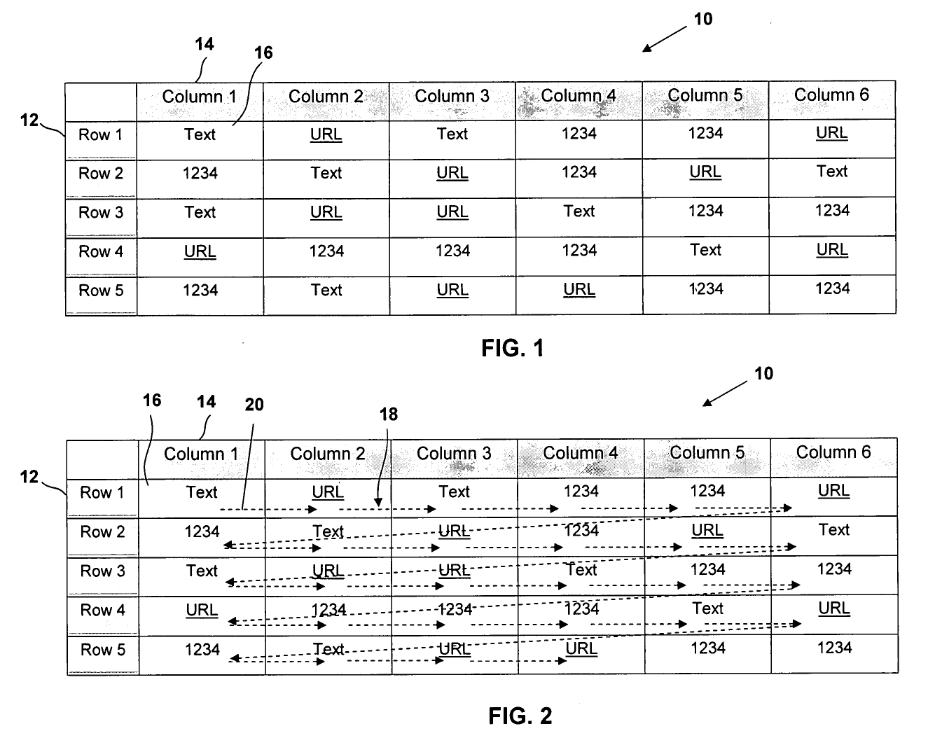

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for type-based table navigation. In particular, the present invention allows a user to quickly navigate to and between cells of a table based on the data type contained within the cells. This reduces the number of cells a user is required to navigate because only the cells containing data of a desired data type are navigable and all other cells are skipped.

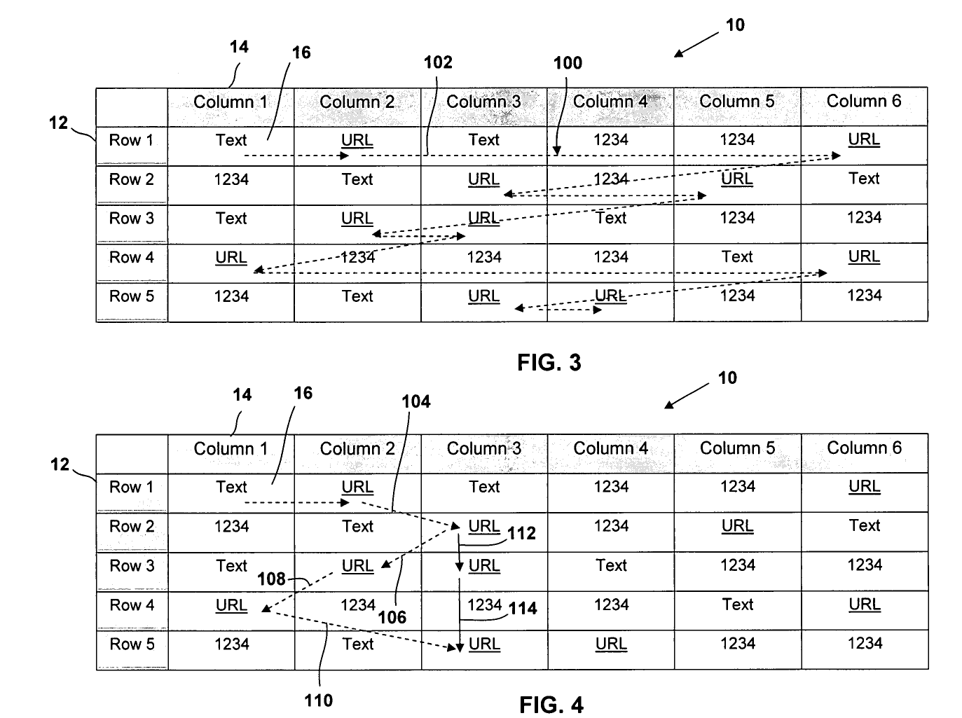

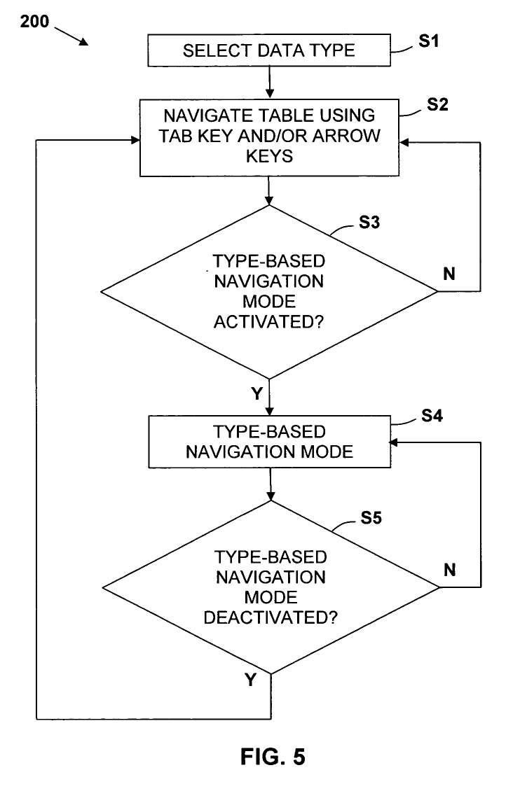

An illustrative navigation path 100 in accordance with an embodiment of the present invention from the first cell 16 in table 10 (i.e., row 1, column 1) to the last cell 16 in table 10 containing an URL data type (i.e., row 5, column 4) is shown in FIG. 3. In, this case, a user desires to search through table 10 for cells containing an URL data type (i.e., an URL data type is selected by the user). After entering a type-based navigation mode in accordance with the present invention, and selecting an URL data type, only the cells 16 in table 10 that contain an URL data type are selected when tabbing through table 10, while the cells 16 in table 10 containing other data types (e.g., text, numbers, etc.) are skipped. Each actuation of the tab key is represented by a dashed arrow 102. As can be seen in FIG. 3, the tab key only needs to be pressed ten times to navigate through table 10 from the first cell 16 in table 10 (i.e., row 1, column 1) to each of the cells 16 in table 10 containing an URL data type. This compares favorably to the twenty-seven tabs required by the prior art method illustrated in FIG. 2.

Navigation in the reverse direction to cells 16 of table 10 containing an URL data type can be accomplished using, for example, a conventional shift-tab key combination or using another predetermined key or key combination. Again, while navigating in the reverse direction, cells 16 in table 10 containing data types other than an URL data type are skipped.

It should be noted that navigation in the type-based navigation mode can be carried out using keyboard keys in addition to, or other than, the tab key. For example, the right and left arrow keys can be used to navigate forward and backward between cells of a selected data type in a table. Further, the up and down arrow keys can be used to navigate to a first instance (or the closest instance) of the selected data type in a higher or lower row, respectively, of a table. Other non-keyboard techniques can also be used to navigate between cells of the selected data type while in the type-based navigation mode. For example, while in the type-based navigation mode a user can click a button on a mouse or other input device to navigate between cells of the selected data type. Many other techniques are also possible.

An example of the use of the down arrow key is illustrated in FIG. 4. As shown, while in the type-based navigation mode, after selecting the first cell 16 in row 1 containing an URL data type (i.e., row 1, column 2), the user uses the down arrow key to navigate to the first cell 16 in row 2 containing an URL data type (i.e., row 2, column 3). This is indicated by dashed arrow 104. When the down arrow key is used again, the first cell 16 in row 3 containing an URL data type is then selected (i.e., row 3, column 2) as indicated by dashed arrow 106. Subsequent actuations of the down arrow key result in the selection of the first cell 16 in row 4 containing an URL (i.e., row 4, column 1) as indicated by dashed arrow 108, and the selection of the first cell 16 in row 5 containing an URL (i.e., row 5, col. 4) as indicated by dashed arrow 110. It should be noted that a row not having a cell 16 containing an URL data type would be skipped. Alternatively, for closest cell navigation (e.g., starting from the cell 16 in row 2, column 3), the closest cell 16 containing an URL data type below row 2 would be selected (i.e., row 3, column 3) as indicated by solid arrow 112, and the closest cell 16 containing an URL data type below row 3 would be selected (i.e., row 5, column 3) as indicated by solid arrow 114.

It should be also be noted that the present invention is not limited to use with tables. For example, the present invention can be used to navigate among the cells of a spreadsheet. In addition, the present invention can be used to navigate through an application containing fields (e.g., a 3270 or 5250 application), or through a dialog window having multiple graphical user interface (GUI) controls (cells). Many other possibilities also exist. In general, the present invention can be used to navigate through selectable data, cells, objects, fields, controls, and the like.

A flow diagram 200 of a method in accordance with the present invention is illustrated in FIG. 4. In step S1, a user selects a data type to be searched. The data type may comprise, for example, text, an URL, or a number as described above. In addition, the data type may comprise empty cells, required cells (e.g., in a template or form), cells with misspellings, cells with text matching a search criteria, cells that only allow numbers, cells matching any of the standard database types, etc. Many other data types are also possible, and the above examples are not intended to be limiting. The data type may be selected in any now known or later developed manner. For example, the data type may be selected via a menu, a search box, a pop-up window, a keyboard (e.g., “alt-t” to select text), using a toolbar button, etc. In addition, the data type may be implicitly selected based on the last selected data type.

In step S2, the user navigates through the cells of a table using the tab key and/or arrow keys, or in any other suitable manner. Navigation continues in this manner until the user activates (step S3) the type-based navigation mode of the present invention. The type-based navigation mode can be activated, for example, by pressing and holding the space bar or other predetermined key (e.g., right arrow, F10, etc.) or key combination (e.g., control-key, alt-key, etc.) on the keyboard while navigating the table using the tab and/or arrow keys. In this case of the space bar, navigation in the type-based navigation mode continues (step S4) until the user releases the space bar. Upon deactivation of the type-based navigation mode (step S5), flow passes back to step S2. It should be noted that the user could alternatively activate the type-based navigation mode first and then select a data type to be searched while in the type-based navigation mode.

Many other techniques for activating/deactivating the type-based navigation mode are also possible, and can include, for example, pressing a key (e.g., space bar, function key, etc.) or key combination (e.g., control-key, alt-key, etc.) to activate the type-based navigation mode and subsequently pressing the same or different key or key combination to deactivate the type-based navigation mode. Further, the type-based navigation mode can be activated/deactivated by selecting a toolbar button, selecting a command from a menu, opening a dialog box and selecting an option to enter/leave the type-based navigation mode, etc. It will be apparent to one skilled in the art that any suitable now known or later developed technique can be used to activate/deactivate the type-based navigation mode of the present invention.

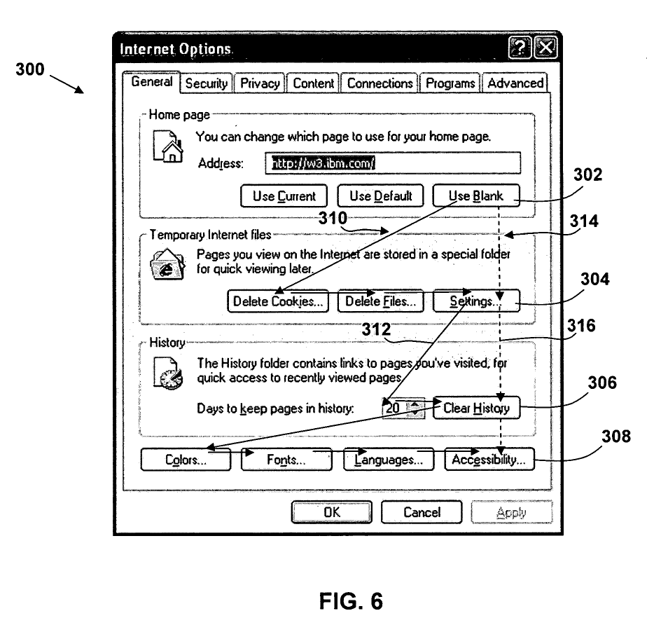

Another embodiment of the present invention is illustrated in FIG. 6. In this embodiment, the type-based navigation of the present invention is used to navigate the control buttons (cells) of a GUI dialog box 300. In this example, the dialog box 300 comprises Internet Explorer's Internet Options dialog. This dialog can be found by opening Internet Explorer (available from Microsoft, Inc.) and selecting Internet Options.

In the dialog box 300, it is assumed that the Use Blank button 302 is currently selected. Conventionally, the tab key would need to be pressed three times to move the focus of the dialog box 300 to the Settings button 304, even though the Settings button 304 is located directly below the Use Blank button 302. Likewise, the tab key would need to be pressed another two times to move the focus to the Clear History button 306, and another four times to move the focus to the Accessibility button 308. The navigation path 310 followed by the tab button through the dialog box 300 is depicted by the solid arrows 312 in FIG. 6.

Using the type-based navigation of the present invention, however, assuming that a data type of “control button” has been selected, greatly simplifies navigation through the dialog box 300. Using the above example, after entering the type-based navigation mode, a user can intuitively use the down arrow to move the focus of the dialog box 300 directly downward from the Use Blank button 302 to the Setting button 304, the Clear History button 306, and Accessibility button 310. The navigation path 314 followed by the tab button through the dialog box 300 is depicted by the dashed arrows 316 in FIG. 6. The up, right, and left arrow keys could be used in a similar manner to intuitively navigate up, right, and left through the control buttons of the dialog box 300. As can be seen by comparing the navigation paths 310 and 314, the navigation path followed using the type-based navigation of the present invention greatly reduces the number of required keystrokes.

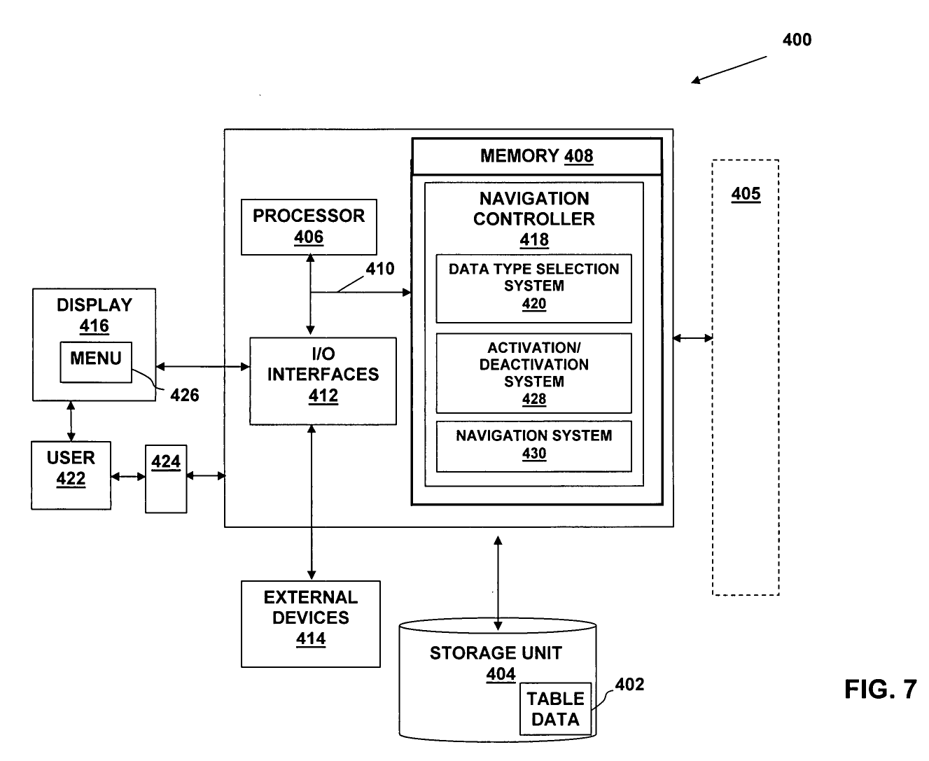

Referring now to FIG. 7, there is illustrated a computer system 400 for providing type-based table navigation in accordance with the present invention. Computer system 400 is intended to represent any type of computerized system capable of implementing the methods of the present invention. For example, computer system 400 may comprise a desktop computer, laptop computer, workstation, server, hand-held device, pager, etc.

Data 402 arranged in a form (e.g., table, spreadsheet, fields, buttons, etc.) that can be navigated using the methods of the present invention can be stored locally to computer system 400, for example, in storage unit 404, and/or may be provided to computer system 400 over a network 405. Storage unit 404 can be any system capable of providing storage for data and information under the present invention. As such, storage unit 404 may reside at a single physical location, comprising one or more types of data storage, or may be distributed across a plurality of physical systems in various forms. In another embodiment, storage unit 404 may be distributed across, for example, a local area network (LAN), wide area network (WAN) or a storage area network (SAN) (not shown). Network 405 is intended to represent any type of network over which data can be transmitted. For example, network 405 can include the Internet, a wide area network (WAN), a local area network (LAN), a virtual private network (VPN), a WiFi network, a personal area network (PAN), or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, computer system 400 generally includes a processor 406, memory 408, bus 410, input/output (I/O) interfaces 412 and external devices/resources 414. Processor 406 may comprise a single processing unit, or may be distributed across one or more processing units in one or more locations, e.g., on a client and server. Memory 408 may comprise any known type of data storage and/or transmission media, including magnetic media, optical media, random access memory (RAM), read-only memory (ROM), etc. Moreover, similar to processor 406, memory 408 may reside at a single physical location, comprising one or more types of data storage, or be distributed across a plurality of physical systems in various forms.

I/O interfaces 412 may comprise any system for exchanging information to/from an external source. External devices/resources 414 may comprise any known type of external device, including speakers, a CRT, LED screen, handheld device, keyboard, mouse, voice recognition system, speech output system, printer, monitor/display (e.g., display 416), facsimile, pager, etc.

Bus 410 provides a communication link between each of the components in computer system 400, and likewise may comprise any known type of transmission link, including electrical, optical, wireless, etc. In addition, although not shown, other components, such as cache memory, communication systems, system software, etc., may be incorporated into computer system 400.

Shown in memory 408 is a navigation controller 418, which may be provided as a computer program product. The navigation controller 418 is configured to provide type-based navigation through the data 402 in a table, spreadsheet, dialog box, application, etc., in accordance with the methods of the present invention.

The navigation controller 418 includes a data type selection system 420 that allows a user 422 to select a data type for navigation. User 422 can select the data type using a keyboard 424, via a menu 426 displayed on display 416, and/or using any other suitable or available method. Navigation controller 418 also includes an activation/deactivation system 428 that allows a user to selectively activate/deactivate the type-based navigation mode when navigating data. Navigation controller 418 further includes a navigation system 430 for providing conventional and type-based navigation of data based on the data type selected by a user via the data type selection system 420 and the state of the activation/deactivation system 428.

It should be appreciated that the teachings of the present invention can be offered as a business method on a subscription or fee basis. For example, computer system 400 could be created, maintained, supported, and/or deployed by a service provider that offers the functions described herein for customers. That is, a service provider could be used to provide type-based table navigation, as describe above.

It should also be understood that the present invention can be realized in hardware, software, a propagated signal, or any combination thereof Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A method for type-based navigation of data, comprising:
selecting a data type;
activating a type-based navigation mode; and
navigating exclusively between data of the selected data type in an arrangement of data, wherein data not of the selected data type in the arrangement of data is skipped.

2. The method of claim 1, wherein the arrangement of data comprises a table, and wherein the table includes a plurality of cells containing data.

3. The method of claim 2, wherein the navigating step further comprises:
actuating a key on a keyboard to navigate between a pair of cells in the table containing data of the selected data type.

4. The method of claim 3, wherein the key comprises a tab key or an arrow key.

5. The method of claim 1, further comprising:
using an input device to navigate between data of the selected data type in the arrangement of data.

6. The method of claim 5, wherein the input device comprises a keyboard, and wherein actuation of a key on the keyboard provides navigation between data of the selected data type in the arrangement of data.

7. The method of claim 1, further comprising:
selectively activating the type-based navigation mode to navigate exclusively between data of the selected data type in the arrangement of data; and
selectively deactivating the type-based navigation mode to navigate between any data in the arrangement of data regardless of data type.

8. A system for type-based navigation of data, comprising:
a system for selecting a data type;
a system for activating a type-based navigation mode; and
a system for navigating exclusively between data of the selected data type in an arrangement of data, wherein data not of the selected data type in the arrangement of data is skipped.

9. The system of claim 8, wherein the arrangement of data comprises a table, and wherein the table includes a plurality of cells containing data.

10. The system of claim 9, wherein the navigating is provided by actuating a key on a keyboard to navigate between a pair of cells in the table containing data of the selected data type.

11. The system of claim 10, wherein the key comprises a tab key or an arrow key.

12. The system of claim 8, further comprising:
an input device for navigating between data of the selected data type in the arrangement of data.

13. The system of claim 12, wherein the input device comprises a keyboard, and wherein actuation of a key on the keyboard provides navigation between data of the selected data type in the arrangement of data.

14. The system of claim 8, further comprising:
a system for selectively activating the type-based navigation mode to navigate exclusively between data of the selected data type in the arrangement of data; and
a system for selectively deactivating the type-based navigation mode to navigate between any data in the arrangement of data regardless of data type.

15. A program product stored on a recordable medium for type-based navigation of data, which when executed comprises:
program code for selecting a data type;
program code for activating a type-based navigation mode; and
program code for navigating exclusively between data of the selected data type in an arrangement of data, wherein data not of the selected data type in the arrangement of data is skipped.

16. The program product of claim 15, wherein the arrangement of data comprises a table, and wherein the table includes a plurality of cells containing data.

17. The program product of claim 16, wherein the program code for navigating further comprises:
program code for navigating between a pair of cells in the table containing data of the selected data type in response to an actuation of a key on a keyboard.

18. The program product of claim 17, wherein the key comprises a tab key or an arrow key.

19. The program product of claim 15, further comprising:
program code for using an input device to navigate between data of the selected data type in the arrangement of data.

20. The program product of claim 19, wherein the input device comprises a keyboard, and wherein actuation of a key on the keyboard provides navigation between data of the selected data type in the arrangement of data.

21. The program product of claim 15, further comprising:
program code for selectively activating the type-based navigation mode to navigate exclusively between data of the selected data type in the arrangement of data; and
program code for selectively deactivating the type-based navigation mode to navigate between any data in the arrangement of data regardless of data type.

22. A method for deploying an application for type-based navigation of data, comprising:
providing a computer infrastructure being operable to:
select a data type;
activate a type-based navigation mode; and
navigate exclusively between data of the selected data type in an arrangement of data, wherein data not of the selected data type in the arrangement of data is skipped.

23. Computer software embodied in a propagated signal for type-based navigation of data, the computer software comprising instructions to cause a computer system to perform the following functions:
select a data type;
activate a type-based navigation mode; and
navigate exclusively between data of the selected data type in an arrangement of data, wherein data not of the selected data type in the arrangement of data is skipped.
